(19) United States
(12) Patent Application Publication
(10) Pub. No.: US 2009/0110978 A1
(43) Pub. Date: Apr. 30, 2009

(54) FUEL CELL SYSTEM

(75) Inventors: Sung-Chul LEE, Yongin-si (KR); Ju-Yong KIM, Yongin-si (KR); Woo-Cheol SHIN, Yongin-si (KR); Yong-Kul LEE, Yongin-si (KR); Sang-Jun KONG, Yongin-si (KR); Man-Seok HAN, Yongin-si (KR); In-Hyuk SON, Yongin-si (KR); Jin-Goo AHN, Yongin-si (KR); Tae-Keun KIM, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/122,154

(22) Filed: May 16, 2008

(30) Foreign Application Priority Data
Oct. 30, 2007 (KR) 10-2007-0109502

(51) Int. Cl. H01M 8/06

(52) U.S. Cl. 429/20

(57) ABSTRACT

A fuel cell system that effectively processes a flue gas generated from a heat source of a fuel reforming apparatus. The fuel reforming apparatus generates a reforming gas containing hydrogen through a reformation reaction of the fuel from a fuel supply, and a fuel cell main body generates electrical energy through an electrochemical reaction of the reforming gas with an oxidizing agent. The fuel reforming apparatus includes a reforming reaction part and a heat source. The reforming reaction part induces a reforming reaction in the fuel, and the heat source provides heat energy to the reforming reaction part. A flue gas postprocessor induces an oxidation-reduction reaction in a flue gas exhausted by a combustion reaction of the heat source to decrease toxic ingredients, such as CO, hydrocarbons, and NOₓ, in the flue gas.

### CROSS-REFERENCE TO RELATED APPLICATIONS

This application claims the benefit of Korean Patent Application No. 2007-109502 filed in the Korean Intellectual Property Office on Oct. 30, 2007, which is incorporated herein by reference.

### BACKGROUND OF THE INVENTION

1. Field of the Invention

Aspects of the present invention relate to a fuel cell system, and more particularly, to a fuel cell system for effectively post-processing a flue gas generated from a heat source of a fuel reforming apparatus.

2. Description of the Related Art

Fuel cells form an electricity generating system to generate electrical energy using a hydrocarbon group fuel. Such fuel cells are generally classified into polymer electrolyte membrane fuel cells and direct oxidation membrane fuel cells. The direct oxidation membrane fuel cell is generally referred to as a direct methanol fuel cell (DMFC).

The polymer electrolyte membrane fuel cell has superior output characteristics, a low operating temperature, and fast starting and response characteristics. The polymer electrolyte membrane fuel cell has been widely used as a portable power source for vehicles, a distributed power source for houses and public buildings, and a mini power source for electronic devices.

A fuel cell system employing the polymer electrolyte membrane fuel cell includes a fuel cell main body, a fuel reforming apparatus, a fuel supply, and an oxidizing agent supply. The fuel supply includes a fuel tank and a fuel pump, and the fuel supply supplies a fuel to the fuel reforming apparatus. The fuel reforming apparatus generates a hydrogen gas by reforming the fuel and supplies the hydrogen gas to the fuel cell main body. The fuel cell main body generates electrical energy by inducing an electrochemical reaction between the hydrogen gas from the fuel reforming apparatus and the oxidizing agent.

In the fuel cell system, the fuel reforming apparatus includes a heat source to generate heat and a reforming reaction part to reform a fuel using the heat energy. The heat source may be classified into a burner type and a catalytic oxidation type according to a heat generation structure. Both of the burner type heat source and the catalytic oxidation type heat source exhaust a flue gas from combustion. The flue gas contains toxic ingredients, such as carbon monoxide (CO), hydrocarbon, and nitrogen oxide (NOₓ).

Although the flue gas contains toxic ingredients, technologies for eliminating the toxic ingredients from the flue gas have not been introduced and research thereon has not been actively progressed because the toxic ingredients have less influence on environmental pollution than other pollutants. However, many advanced nations, including the European Union (EU), have been strictly enforcing anti-pollution laws. Therefore, it is necessary to develop a technology for eliminating toxic ingredients from the flue gas.

The above information disclosed in this Background section is only for enhancement of understanding of the background of the invention and therefore it may contain information that does not form the prior art that is already known in this country to a person of ordinary skill in the art.

### SUMMARY OF THE INVENTION

Aspects of the present invention provide a fuel cell system to effectively remove toxic ingredients, such as CO, hydrocarbons, and NOₓ, contained in a flue gas by post-processing the flue gas generated from a heat supply of a fuel reforming apparatus.

According to aspects of the present invention, there is provided a fuel cell system including a fuel supply, a fuel reforming apparatus, and a fuel cell main body. According to aspects of the present invention, the fuel reforming apparatus generates a reforming gas containing hydrogen through reformation of the fuel from the fuel supply, and the fuel cell main body generates electrical energy through an electrochemical reaction of the reforming gas with an oxidizing agent. According to aspects of the present invention, the fuel reforming apparatus includes a reforming reaction part, and a heat source. According to aspects of the present invention, the reforming reaction part induces a reformation reaction in the fuel, and the heat source generates and provides heat energy to the reforming reaction part. According to aspects of the present invention, the flue gas postprocessor induces an oxidation-reduction reaction on a flue gas exhausted by the combustion reaction of the heat source.

According to aspects of the present invention, the flue gas postprocessor may be filled with a reducing agent including a hydrogen compound or supplied with a reducing agent including a hydrogen compound.

According to aspects of the present invention, the reforming gas may be provided as a reducing agent to the flue gas postprocessor from the reforming reaction part.

According to aspects of the present invention, a flue gas discharge pipe may be connected between the heat source and the flue gas postprocessor, and a reforming gas supply pipe may be connected between the reforming reaction part and the fuel cell main body. According to aspects of the present invention, the reforming gas may flow to the flue gas discharge pipe through a reforming gas branch pipe disposed between the reforming gas supply pipe and the flue gas discharge pipe.

According to aspects of the present invention, a controller may be disposed in the reforming gas branch pipe to control a quantity of the reforming gas supplied to the flue gas postprocessor, and the first controller may be one of a pump and a valve.

According to aspects of the present invention, the flue gas postprocessor may be supplied with an anode tail gas (ATG) exhausted from the fuel cell main body after the electrochemical reaction from the fuel cell main body.

According to aspects of the present invention, a flue gas discharge pipe may be connected between the heat source and the flue gas postprocessor, and the ATG may be supplied to the flue gas discharge pipe through the ATG discharge pipe disposed between the fuel cell main body and the flue gas discharge pipe.

According to aspects of the present invention, a controller may be disposed in the ATG discharge pipe to control a quantity of the ATG supplied to the flue gas postprocessor, and the controller may be one of a pump and a valve.

According to aspects of the present invention, the fuel cell system may further include an oxidizing agent supply for supplying the oxidizing agent to the fuel cell main body.

According to aspects of the present invention, the heat source may induce a reaction of the fuel and the air in a lean burn condition.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a fuel cell system according to an exemplary embodiment of the present invention;

FIG. 2 is a schematic diagram of a fuel cell system according to an exemplary embodiment of the present invention;

FIG. 3 is a schematic diagram of a fuel cell system according to an exemplary embodiment of the present invention;

FIG. 4 is a perspective view of a fuel cell main body shown in FIG. 3;

FIG. 5 is a graph showing an amount of NOₓ contained in a flue gas, which is measured using a fuel cell system shown in FIG. 3; and

FIG. 6 is a schematic diagram of a fuel cell system according to an exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

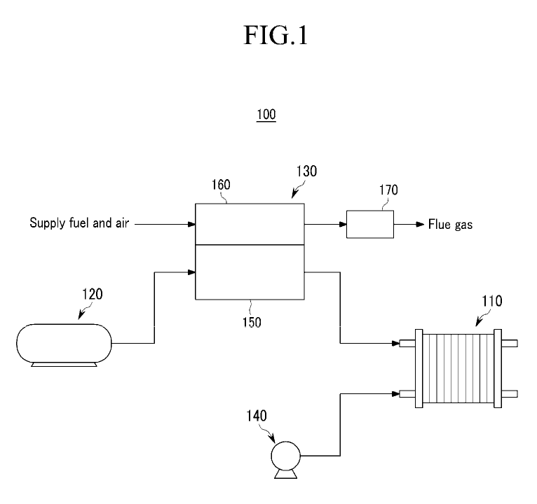

FIG. 1 is a schematic diagram of a fuel cell system 100 according to an exemplary embodiment of the present invention. As shown in FIG. 1, the fuel cell system 100 includes a flue gas postprocessor 170 to process a flue gas generated by a combustion reaction of a heat source 160. The fuel cell system 100 has a structural characteristic that drives the heat source 160 in a lean burn condition and induces an oxidation-reduction reaction in the flue gas postprocessor 170. Accordingly, the fuel cell system 100 removes toxic ingredients such as carbon monoxide (CO), hydrocarbon, and nitrogen oxide (NOₓ), which are contained in the flue gas.

The fuel cell system 100 may include a fuel cell main body 110, a fuel supply 120, a fuel reforming apparatus 130, and an oxidizing agent supply 140.

The fuel cell main body 110 generates electrical energy by inducing an electrochemical reaction of a reforming gas containing hydrogen and an oxidizing agent gas containing oxygen. The fuel cell main body 110 has a stacked structure in which a plurality of unit cells are consecutively stacked. A unit cell is the minimum unit for generating electrical energy. In general, the stacked structure of the fuel cell main body 110 is referred to as a fuel cell stack. The fuel cell main body 110 is a set of a plurality of consecutively arranged unit cells. An end plate is connected to at least one side of the consecutively arranged unit cells.

The fuel supply 120 may include a fuel tank to store a fuel and a pump to supply the fuel to the fuel reforming apparatus 130.

The fuel reforming apparatus 130 receives the fuel from the fuel supply 120, induces a reforming reaction in the fuel, and generates a reforming gas containing hydrogen from the fuel.

The oxidizing agent supply 140 supplies an oxidizing agent gas to the fuel cell main body 110. The oxidizing agent supply 140 may supply air in the atmosphere to the fuel cell main body 110 as an oxidizing agent gas using an air pump.

The fuel cell system 100 can induce the reforming reaction in a fuel using the fuel reforming apparatus 130 that has the following structure. That is, the fuel reforming apparatus 130 may include various constituent elements according to a fuel reforming scheme. Basically, the fuel reforming apparatus 130 may include an evaporator, a reforming reaction part 150, and a heat source 160 to produce a steam reforming reaction.

The evaporator heats water and generates steam to provide steam to the reforming reaction part 150 for the steam reforming reaction. Then, the reforming reaction part 150 generates a reforming gas containing hydrogen through the reforming reaction of the fuel using the heat energy provided from the heat source 160.

The heat source 160 may be classified into a burner type and a catalytic oxidation type according to a structure to generate heat energy. The burner type heat source generates heat energy using a flame. The catalytic oxidation type heat source generates heat energy from a catalytic oxidation reaction of the fuel and the air on a catalyst layer. Accordingly, the heat source 160 discharges a flue gas generated from the combustion.

However, the flue gas contains toxic ingredients such as CO, hydrocarbons, and NOₓ, which are generated from the combustion. Such toxic ingredients of the flue gas may contaminate the environment if the toxic ingredients are exhausted thereto. In order to prevent the toxic ingredients from entering the environment, the fuel cell system 100 removes CO and hydrocarbons from the flue gas to lower than a predetermined reference value by reacting the fuel and the air in a lean burn condition in the heat source 160. Here, the flue gas postprocessor 170 removes NOₓ from the flue gas.

The flue gas postprocessor 170 removes the NOₓ from the flue gas until a NOₓ content decreases to a predetermined reference value through an oxidation-reduction reaction that bonds NOₓ contained in the flue gas to a reducing agent. That is, if the NOₓ reacts with the reducing agent (for example, a hydrogen compound), it reforms to N₂ and H₂O. The flue gas postprocessor 170 can remove NOₓ contained in the flue gas. The reducing agent may fill the fuel gas postprocessor 170 or is provided from the outside.

Further, the flue gas postprocessor 170 may employ a three-way catalytic method as another method for removing toxic ingredients in a flue gas. The three-way catalytic method eliminates oxygen from a flue gas. Therefore, the three-way catalytic method can simultaneously remove three components CO, hydrocarbons, and NOₓ. The flue gas postprocessor 170 may employ the three-way catalytic method for additionally removing ingredient toxics contained in the flue gas in the fuel cell system 100 of FIG. 1.

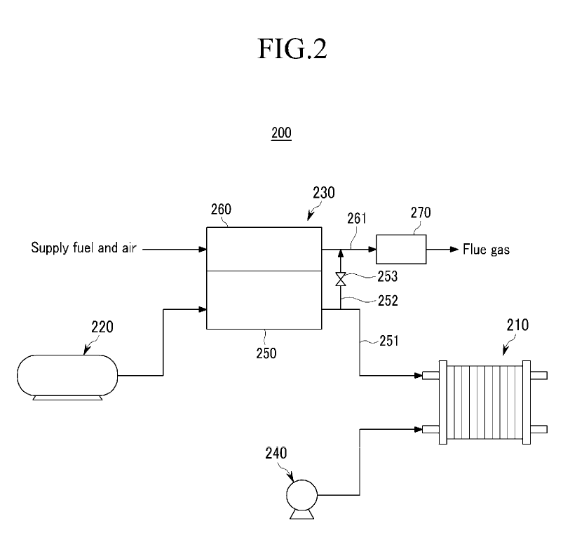

FIG. 2 is a schematic diagram of a fuel cell system 200 according to an exemplary embodiment of the present invention. As shown in FIG. 2, the fuel cell system 200 includes a fuel cell main body 210, a fuel supply 220, a fuel reforming apparatus 230, and an oxidizing agent supply 240 like the fuel cell system 100. Like the fuel cell system 100 of FIG. 1, the fuel reforming apparatus 230 includes a reforming reaction part 250 to induce a reforming reaction in a fuel, a heat source 260 to provide heat energy, and a flue gas postprocessor 270 to process a flue gas output from the heat source 260.

Particularly, the fuel cell system 200 supplies the reforming gas to the flue gas postprocessor 270 where the reforming gas is generated by the reforming reaction part 250 from the reforming reaction of the fuel. That is, the fuel cell system 200 uses the reforming gas as the reducing agent. Since the reforming gas contains a large amount of hydrogen from the reforming reaction of the fuel, the fuel cell system 200 can effectively eliminate NOₓ contained in the flue gas through an oxidation-reduction reaction.

The fuel cell system 200 also includes a flue gas discharge pipe 261 connected between the heat source 260 and the flue gas postprocessor 270, and a reforming gas supply pipe 251 connected between the reforming reaction part 250 and the fuel cell main body 210. Then, the reforming gas flows in the flue gas discharge pipe 261 through a reforming gas branch pipe 252 that connects the reforming gas supply pipe 251 and the flue gas discharge pipe 261.

A controller 253 is disposed at the reforming gas branch pipe 252 to control the flow amount of the reforming gas. Various mechanical elements may be used as the controller 253. For example, one of a pump and a valve may be disposed as the controller 253. As described above, the fuel cell system 200 prevents an excessive amount of reforming gas from flowing into the flue gas discharge pipe 261 via the controller 253.

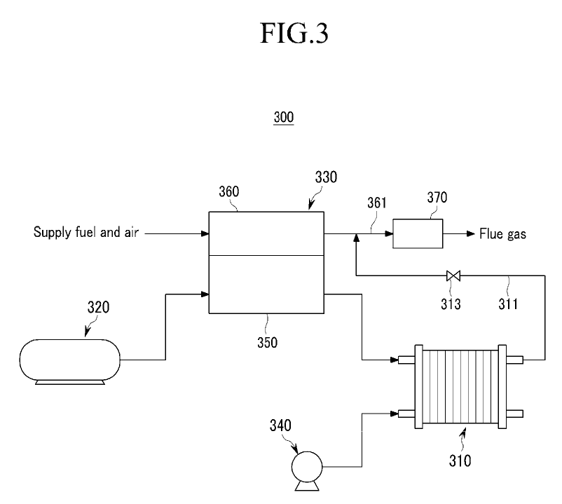

FIG. 3 is a schematic diagram of a fuel cell system according to an exemplary embodiment of the present invention. As shown in FIG. 3, the fuel cell system 300 includes a fuel cell main body 310, a fuel supply 320, a fuel reforming apparatus 330, and an oxidizing agent supply 340 like the fuel cell system 100 of FIG. 1. The fuel reforming apparatus 330 includes a reforming reaction part 350 to induce the reforming reaction of a fuel, a heat source 360 to supply heat energy to the reforming reaction part 350, and a flue gas postprocessor 370 to process a flue gas output from the heat source 360.

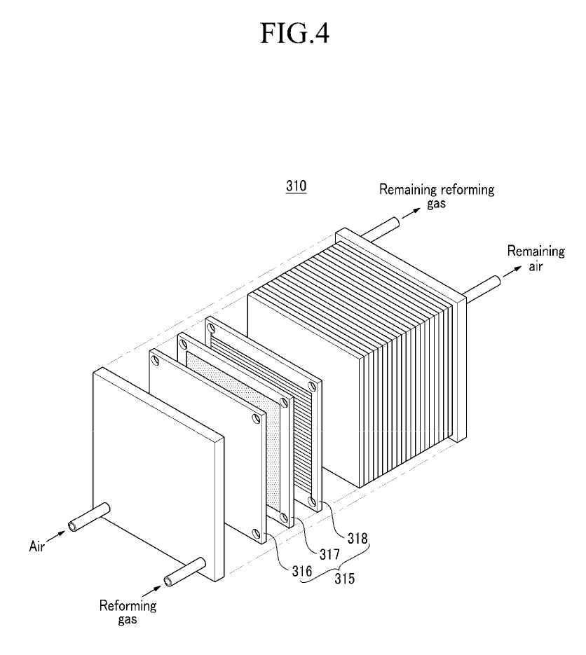

The fuel cell system 300 supplies an anode tail gas (ATG), which is output from the fuel cell main body 310 after generating electricity from the reforming gas, to the flue gas postprocessor 370. As shown in FIG. 4, the fuel cell main body 310 outputs the ATG after generating electricity in the following structure. That is, with reference to FIG. 4, the fuel cell main body 310 has a stacked structure in which unit cells 315 are consecutively stacked. Here, a unit cell is the minimum unit for generating electrical energy. The unit cell 315 includes a membrane-electrode assembly (MEA) 317 to induce an electrochemical reaction, and first and second separators 316 and 318 disposed at both sides of the membrane-electrode assembly 317. The first separator 316 is closely adhered to a cathode side of the membrane-electrode assembly 317 and an oxidizing agent gas flows in through a first channel (not shown) that is formed at the cathode side. The second separator 318 is closely adhered to an anode side of the membrane-electrode assembly 317 and a reforming gas flows in through a second channel (not shown) that is formed at the anode side. As described above, the fuel cell main body 310 induces the electrochemical reaction of hydrogen and oxygen at the membrane-electrode assembly 317 and discharges the unused hydrogen in the ATG to the outside. Further, the above fuel cell main body 310 is not limited to the above-described structure such that both sides of each of the first and second separators 316 and 318 may have channels to deliver the reforming gas to the anode side of the MEA 317 and the oxidizing agent gas to the cathode of the MEA 317.

The fuel cell system 300 uses the ATG as a reducing agent. Since the ATG is a reforming gas that is not electrochemically reacted while passing through the fuel cell main body 310, the ATG also contains a large amount of hydrogen, similar to the reforming gas. Therefore, the fuel cell system 300 can effectively remove NOₓ in the flue gas by inducing an oxidation-reduction reaction between the ATG and NOₓ.

The fuel cell system 300 includes a flue gas discharge pipe 361 connected between the heat source 360 and the flue gas postprocessor 370. Then, the ATG is supplied to the flue gas discharge pipe 361 through an ATG discharge pipe 311 that connects the fuel cell main body 310 and the flue gas discharge pipe 361.

A controller 313 is disposed in the ATG discharge pipe 311 to control the flow amount of the ATG. Various mechanical elements can be used as the controller 313. For example, one of a pump and a valve may be the controller 313. As described above, the fuel cell system 300 can control the flow amount of the ATG via the controller 313.

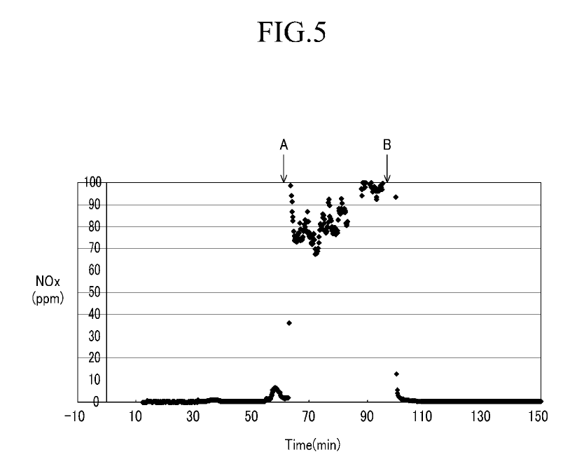

FIG. 5 is a graph showing an amount of NOₓ contained in a flue gas, which is measured using a fuel cell system 300 shown in FIG. 3. That is, the graph shown in FIG. 5 shows a result of simulating the performance of the flue gas postprocessor 370 using the fuel cell system 300 as shown in FIG. 3.

In the simulation, the combustion of the heat source 360 was simulated as supplying air at 30 L/min and a fuel at 1.2 L/min to the heat source 360. NOₓ in the flue gas abruptly increased to about 100 ppm after starting the combustion of the heat source 360 (point A). In the simulation, an ATG of about 400 cc/min was constantly supplied after about 20 minutes (point B). Here, the ATG is output from the fuel cell main body 310. As a result, NOₓ in the flue gas decreased down to about 3 ppm.

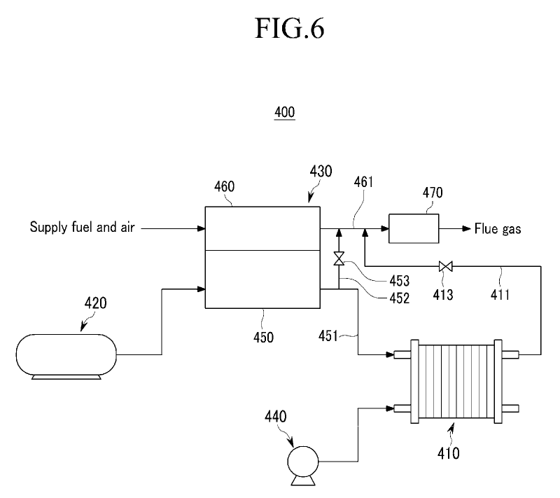

FIG. 6 is a schematic diagram of a fuel cell system 400 according to an exemplary embodiment of the present invention. As shown in FIG. 6, the fuel cell system 400 includes a fuel cell main body 410, a fuel supply 420, a fuel reforming apparatus 430, and an oxidizing agent supply 440 like the fuel cell system 100 of FIG. 1. The fuel reforming apparatus 430 also includes a reforming reaction part 450 to induce the reforming reaction of a fuel, a heat source 460 to provide heat energy to the reforming reaction part 450, and a flue gas postprocessor 470 to process a flue gas output from the heat source 460.

The fuel cell system 400 combines the structural characteristics of the fuel cell system 200 according to FIG. 2 with the structural characteristics of the fuel cell system 300 according to FIG. 3.

That is, the fuel cell system 400 includes a flue gas discharge pipe 461 connected between the heat source 460 and the flue gas postprocessor 470, and a reforming gas supply pipe 451 connected between the reforming reaction part 450 and the fuel cell main body 410. Then, the reforming gas can flow in the flue gas discharge pipe 461 through a reforming gas branch pipe 452 that connects the reforming gas supply pipe 451 and the flue gas discharge pipe 461. Also, the ATG can be supplied to the flue gas discharge pipe 461 through an ATG discharge pipe 411 that connects the fuel cell main body 410 and the flue gas discharge pipe 461.

Then, a first controller 453, such as a valve or a pump, is disposed in the reforming gas branch pipe 453, and a second controller 413, such as a valve or a pump, is disposed in the ATG discharge pipe 411. The first controller 453 and the second controller 413 may be connected to each other so as to be selectively driven. Therefore, the fuel cell system 400 can supply the reforming gas from the reforming reaction part 450 or the ATG from the fuel cell main body 410 to the flue gas discharge pipe 461 in consideration of the necessary amount of reducing agent to process the flue gas.

As described above, the fuel cell system according to aspects of the present invention can reduce the toxic ingredient content to a predetermined value by effectively removing toxic ingredients, such as CO, hydrocarbons, and NOₓ, in the flue gas that is generated from the heat source of the fuel reforming apparatus. As a result, the fuel cell system according to an exemplary embodiment of the present invention can satisfy the regulations of the anti-pollution laws of advanced nations, thereby improving exportation and strengthening the competitiveness of a product.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fuel cell system, comprising:
a fuel reforming apparatus to generate a reforming gas containing hydrogen through reformation of a fuel, the fuel reforming apparatus comprising:
a reforming reaction part to induce the reformation reaction of the fuel to form the reforming gas, and
a heat source to generate heat energy and to provide the generated heat energy to the reforming reaction part;
a fuel supply to store and to supply the fuel to the fuel reforming apparatus;
a fuel cell main body to generate electrical energy through an electrochemical reaction of the reforming gas with an oxidizing agent; and
a flue gas postprocessor to induce an oxidation-reduction reaction in a flue gas generated from a combustion reaction in the heat source and exhausted from the heat source.

2. The fuel cell system of claim 1, wherein the flue gas postprocessor is filled with a reducing agent comprising a hydrogen compound.

3. The fuel cell system of claim 1, wherein the post gas processor is supplied with a reducing agent comprising a hydrogen compound.

4. The fuel cell system of claim 1, wherein the reforming gas is provided to the flue gas postprocessor from the reforming reaction part.

5. The fuel cell system of claim 4, further comprising:
a flue gas discharge pipe connected between the heat source and the flue gas postprocessor;
a reforming gas supply pipe connected between the reforming reaction part and the fuel cell main body; and
a reforming gas branch pipe connected between the reforming gas supply pipe and the flue gas discharge pipe,
wherein the reforming gas flows through the reforming gas supply pipe to the flue gas discharge pipe through the reforming gas branch pipe.

6. The fuel cell system of claim 5, further comprising a first controller disposed in the reforming gas branch pipe to control a quantity of the reforming gas supplied from the reforming reaction part to the flue gas postprocessor.

7. The fuel cell system of claim 6, wherein the first controller is one of a pump or a valve.

8. The fuel cell system of claim 1, wherein the flue gas postprocessor is supplied with an anode tail gas (ATG) exhausted from the fuel cell main body after the electrochemical reaction in the fuel cell main body.

9. The fuel cell system of claim 8, further comprising:
a flue gas discharge pipe connected between the heat source and the flue gas postprocessor, and
an ATG discharge pipe connected between the fuel cell main body and the flue gas discharge pipe.

10. The fuel cell system of claim 9, further comprising a first controller disposed in the ATG discharge pipe to control a quantity of the ATG supplied from the fuel cell main body to the flue gas postprocessor.

11. The fuel cell system of claim 10, wherein the first controller is one of a pump and a valve.

12. The fuel cell system of claim 5, further comprising:
an anode tail gas (ATG) discharge pipe connected between the fuel cell main body and the flue gas discharge pipe to supply the ATG exhausted from the fuel cell main body and generated by the electrochemical reaction in the fuel cell main body to the flue gas postprocessor.

13. The fuel cell system of claim 12, further comprising a first controller disposed in the reforming gas branch pipe to control a quantity of the reforming gas supplied from the reforming reaction part to the flue gas postprocessor, and a second controller is disposed in the ATG discharge pipe to control a quantity of the ATG supplied from the fuel cell main body to the flue gas postprocessor.

14. The fuel cell system of claim 13, wherein the first controller is one of a valve and a pump, and the second controller is one of a valve and a pump.

15. The fuel cell system of claim 1, further comprising an oxidizing agent supply to supply the oxidizing agent to the fuel cell main body.

16. The fuel cell system of claim 1, wherein the heat source induces a reaction of a fuel and the air in a lean burn condition.

17. The fuel cell system of claim 9, further comprising:
a reforming gas branch pipe connected between the reforming gas supply pipe and the flue gas discharge pipe,
wherein the reforming gas flows through the reforming gas supply pipe to the flue gas discharge pipe through the reforming gas branch pipe.

18. The fuel cell system of claim 1, wherein the flue gas postprocessor decreases amounts of CO, hydrocarbons, and NOₓ in the flue gas according to a three-way catalytic method.

19. The fuel cell system of claim 1, wherein flue gas postprocessor decreases an amount of NOₓ in the flue gas to less than or about 3 ppm.

20. A fuel cell system, comprising:
a fuel reforming apparatus to generate a reforming gas containing hydrogen through reformation of a fuel, and the fuel reforming apparatus comprising:
a reforming reaction part to induce the reformation reaction of the fuel to form the reforming gas, and
a heat source to generate heat energy and to provide the generated heat energy to the reforming reaction part;
a fuel supply to store and to supply the fuel to the fuel reforming apparatus;
a fuel cell main body to generate electrical energy through an electrochemical reaction of the reforming gas with an oxidizing agent;
a flue gas postprocessor to induce an oxidation-reduction reaction in a flue gas generated from a combustion reaction in the heat source and exhausted from the heat source;
a flue gas discharge pipe connected between the heat source and the flue gas postprocessor through which the flue gas from the heat source flows to the flue gas postprocessor;
a reforming gas supply pipe connected between the reforming reaction part and the fuel cell main body to supply the reforming gas to the fuel cell main body;
a reforming gas branch pipe connected between the flue gas discharge pipe and the reforming gas supply pipe to supply the reforming gas to the flue gas postprocessor, the reforming gas being supplied to the flue gas postprocessor as a reducing agent to decrease toxins from the flue gas; and
an anode tail gas (ATG) discharge pipe connected between the fuel cell main body and the flue gas discharge pipe to supply the ATG generated by the electrochemical reaction in the fuel cell main body and exhausted from the fuel cell main body to the flue gas postprocessor.
